(19) United States
(12) Patent Application Publication
(10) Pub. No.: US 2026/0104975 A1
(43) Pub. Date: Apr. 16, 2026

(54) COST-BASED DYNAMIC ALLOCATION OF TESTING EQUIPMENT

(71) Applicant: Toyota Jidosha Kabushiki Kaisha, Toyota-shi Aichi-ken (JP)

(72) Inventors: Emily S. Lerner, Ypsilanti, MI (US); Joshua Scott Smith, Livonia, MI (US)

(73) Assignee: Toyota Jidosha Kabushiki Kaisha, Toyota-shi Aichi-ken (JP)

(21) Appl. No.: 19/419,903

(22) Filed: Dec. 15, 2025

Related U.S. Application Data
(63) Continuation-in-part of application No. 18/771,089, filed on Jul. 12, 2024.

(51) Int. Cl. G06F 11/22; G06F 9/48; G06F 9/50

(52) U.S. Cl. CPC G06F 11/2294; G06F 9/4881; G06F 9/5044; G06F 2209/5014

(57) ABSTRACT

Embodiments described herein relate to vehicle testing systems. In one implementation, a method includes receiving a request to perform a test involving at least one test device. The method also includes determining characteristics associated with the request including costs. The method also includes creating, using a cost optimization model based, at least in part, on the characteristics, an allocation of a remote device from a testing pool to operate as the at least one test device for executing the test. The method further includes providing the allocation to reserve the remote device and schedule a test session.

### CROSS-REFERENCE TO RELATED APPLICATIONS

This application is a continuation-in-part of prior U.S. Application No. 18/771,089, filed on July 12, 2024.

### TECHNICAL FIELD

The subject matter described herein relates, in general, to reserving testing resources and, more particularly, to allocating testing equipment based on costs to facilitate scheduling of test sessions and reservation of testing equipment.

### BACKGROUND

In the development and validation of vehicle systems, specialized testing equipment is typically needed for evaluating the performance and reliability of various components and subsystems. Traditionally, such equipment is configured for specific testing scenarios, making it difficult to adapt to changing testing requirements or to share resources efficiently across different projects. As the complexity and volume of vehicle testing increases, organizations face significant challenges in managing, maintaining, and allocating testing resources.

Moreover, remote testing equipment that can be accessed via a communication network can be located in different cities or even in different countries, especially when owned and utilized by global companies. In such instances, the cost of accessing and using testing equipment at different locations can vary significantly. These costs include, for example, the cost of electricity and communication bandwidth, which can vary according to the day and time of testing, and electrical loads and bandwidth costs. Accordingly, executing tests on this equipment without considering these factors can lead to unnecessary costs and inefficient disbursement of resources.

### SUMMARY

The embodiments described herein are directed to a testing system for a cost-based, dynamic allocation of testing equipment. As noted above, existing systems for managing testing equipment may not consider costs, leading to the inefficient use of resources and incurring unnecessary costs. Accordingly, in one approach, a testing system resolves this difficulty by actively considering underlying costs when allocating testing resources. Consider that the testing system receives a request to perform a test using at least one test device. The test is executed using the test device, which can be, for example, an electronic control unit (ECU).

Upon receiving the request, in one implementation, the testing system determines various characteristics, including costs, associated with the request for the test device. As mentioned above, in some instances, test devices can be part of a testing pool of remote testing devices located in different cities or countries, and accordingly, may have varying costs of use. For example, the cost of electricity may vary for test devices located in different countries and may further vary based on the time. Moreover, different hardware components associated with the test device may have different operating costs, for example, different electrical loads or bandwidth costs. In further implementations, the testing system can consider other characteristics as well, such as a criticality of the request, a type of test to be executed, etc. Accordingly, the testing system determines the costs and other characteristics associated with executing the test for various remote devices in a pool of testing devices.

In order to optimize testing costs, in one embodiment, the testing system creates a cost-based allocation of one of the remote devices from the testing pool to operate as the test device for executing the test. In one approach, the testing system creates the allocation using an optimization model based on the characteristics, including the costs. The optimization model, in one embodiment, is a machine learning model. In any case, in one approach, the testing system can provide the allocation to facilitate the reservation and scheduling of the test device for a designated test session. The testing system supports dynamic allocation by evaluating the costs and, in some instances, a criticality of each request to minimize costs and enable prioritization and efficient sharing of resources among different users.

In one embodiment, a testing system is disclosed. The testing system includes a processor and a memory communicably coupled to the processor and storing an allocation module including instructions that, when executed by the processor, cause the processor to receive a request to perform a test involving at least one test device. The instructions also cause the processor to determine characteristics associated with the request including costs. The instructions also cause the processor to create, using a cost optimization model based, at least in part, on the characteristics, an allocation of a remote device from a testing pool to operate as the at least one test device for executing the test. The instructions further cause the processor to provide the allocation to reserve the remote device and schedule a test session.

In another embodiment, a non-transitory computer-readable medium is disclosed. The non-transitory computer-readable medium includes instructions that, when executed by a processor, cause the processor to receive a request to perform a test involving at least one test device. The instructions also cause the processor to determine characteristics associated with the request including costs. The instructions also cause the processor to create, using a cost optimization model based, at least in part, on the characteristics, an allocation of a remote device from a testing pool to operate as the at least one test device for executing the test. The instructions further cause the processor to provide the allocation to reserve the remote device and schedule a test session.

In yet another embodiment, a method is disclosed. The method includes receiving a request to perform a test involving at least one test device. The method also includes determining characteristics associated with the request including costs. The method also includes creating, using a cost optimization model based, at least in part, on the characteristics, an allocation of a remote device from a testing pool to operate as the at least one test device for executing the test. The method further includes providing the allocation to reserve the remote device and schedule a test session.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a testing system that is associated with cost-based allocation of test devices.

FIG. 2 illustrates one example of the system of FIG. 1 in a cloud-computing environment.

FIG. 3 illustrates one example of a testing pool of remote test devices.

FIG. 4 illustrates one example of a method for allocating a test device.

### DETAILED DESCRIPTION

The embodiments described herein are directed to a testing system for a cost-based, dynamic allocation of testing equipment. As noted above, existing systems for managing testing equipment may not consider costs, leading to the inefficient use of resources and incurring unnecessary costs. Accordingly, in one approach, a testing system resolves this difficulty by actively considering underlying costs when allocating testing resources. Consider that the testing system receives a request to perform a test using at least one test device. The test is executed using the test device, which can be, for example, an electronic control unit (ECU).

Upon receiving the request, in one implementation, the testing system determines various characteristics, including costs, associated with the request for the test device. As mentioned above, in some instances, test devices can be part of a testing pool of remote testing devices located in different cities or countries, and accordingly, may have varying costs of use. For example, the cost of electricity may vary for test devices located in different countries and may further vary based on the time. Moreover, different hardware components associated with the test device may have different operating costs, for example, different electrical loads or bandwidth costs. In further implementations, the testing system can consider other characteristics as well, such as a criticality of the request, a type of test to be executed, etc. Accordingly, the testing system determines the costs and other characteristics associated with executing the test for various remote devices in a pool of testing devices.

In order to optimize testing costs, in one embodiment, the testing system creates a cost-based allocation of one of the remote devices from the testing pool to operate as the test device for executing the test. In one approach, the testing system creates the allocation using an optimization model based on the characteristics, including the costs. The optimization model, in one embodiment, is a machine learning model. In any case, in one approach, the testing system can provide the allocation to facilitate the reservation and scheduling of the test device for a designated test session. The testing system supports dynamic allocation by evaluating the costs and, in some instances, a criticality of each request to minimize costs and enable prioritization and efficient sharing of resources among different users.

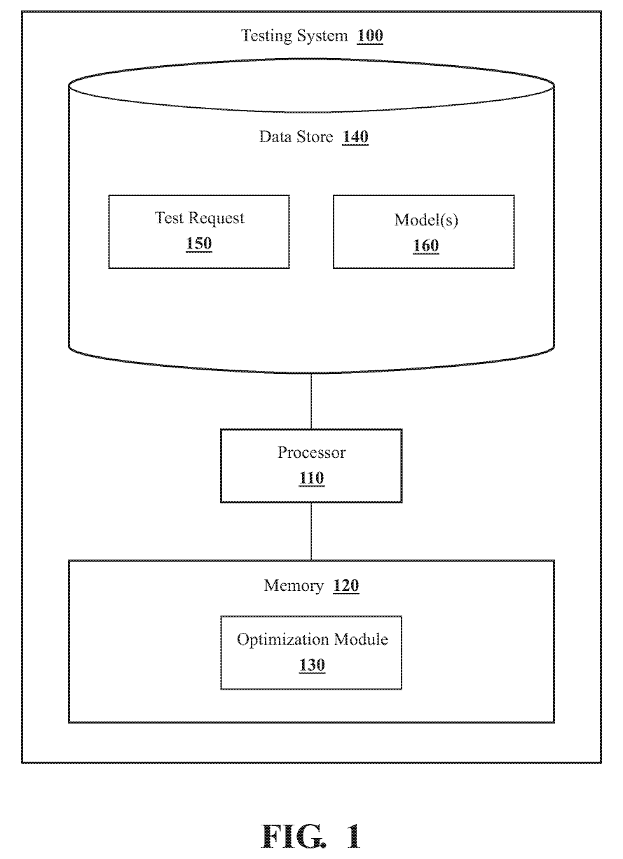

With reference now to FIG. 1, one embodiment of the testing system 100 is illustrated. The testing system 100 is shown as including a processor 110. The processor 110 may be a part of the testing system 100, the testing system 100 may include a separate processor, or the testing system 100 may access the processor 110 through a data bus or another communication path. In one embodiment, the testing system 100 includes a memory 120 that stores an optimization module 130. The memory 120 is a random-access memory (RAM), read-only memory (ROM), a hard-disk drive, a flash memory, or other suitable memory for storing the optimization module 130. The optimization module 130 includes, for example, computer-readable instructions that when executed by the processor 110 cause the processor 110 to perform the various functions disclosed herein. In alternative arrangements, the optimization module 130 includes independent elements from the memory 120 that are, for example, comprised of hardware elements. Thus, the optimization module 130 alternatively includes ASICs, hardware-based controllers, a composition of logic gates, or another hardware-based solution.

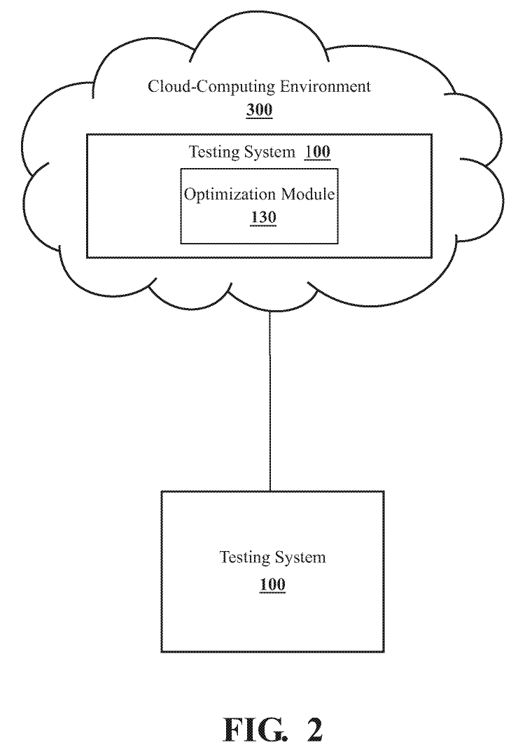

The testing system 100, as illustrated in FIG. 1, is generally an abstracted form of the testing system 100 as may be implemented between a device and a cloud-computing environment. FIG. 2 illustrates one example of a cloud-computing environment 200 that may be implemented along with the testing system 100. As illustrated in FIG. 2, the testing system 100 is embodied at least in part within the cloud-computing environment 200.

Accordingly, as shown, the testing system 100 may include separate instances within one or more entities of the cloud-based environment 200, such as servers, and also instances within one or more remote entities (e.g., computing devices) that function to acquire, analyze, and distribute the noted information. In a further aspect, the set of entities that function in coordination with the cloud environment 200 may be varied.

In one embodiment, the cloud-computing environment 200 includes services that run in a cloud environment, which may be public or private, and which coordinate allocations and reservations, expose request and scheduling interfaces, and enforce access policies. Moreover, in one embodiment, the remote entity includes computing devices accessed by the requesting party that execute the allocations issued by the cloud-computing environment 200. The remote entity reports availability and status, applies reservations, and manages local session control. Communications between the cloud-computing environment 200 and the remote entity occur, in one implementation, over secure network links. In some arrangements, the cloud-computing environment 200 and the remote entity serve logically distinct roles even if employed in the same data center.

With continued reference to FIG. 1, in one embodiment, the testing system 100 includes a data store 140. The data store 140 is, in one embodiment, an electronic data structure stored in the memory 120 or another data store and that is configured with routines that can be executed by the processor 110 for analyzing stored data, providing stored data, organizing stored data, and so on. Thus, in one embodiment, the data store 140 stores data used by the optimization module 130 in executing various functions. In one embodiment, the data store 140 stores a test request 150 and model(s) 160, each of which will be described in turn in further detail below.

Regarding the test request 150, in one embodiment, the test request 150 is a submission provided through a user interface or a programmatic interface, for example, which specifies various testing characteristics for executing the test. The testing system 100, in one approach, receives the submission and stores the submission as the test request 150 in the data store 140. The test request 150 can originate from engineers manipulating an electronic interface, automated pipelines, or project management systems and may arrive in multiple forms. Examples of forms for the test request 150 include a web-form submission via a graphical user interface (GUI) of the testing system 100; an application programming interface (API) call (e.g., REST/JSON) from a continuous integration/continuous deployment (CI/CD) pipeline, a feature testing workflow, or a debugging tool; a machine-readable message placed on a message queue or service bus used by orchestration systems; a scheduled reservation file (e.g., JSON, YAML, CSV) uploaded through a portal or synchronized from a calendar or scheduling system; and/or another human-initiated or machine-generated mechanism for submitting the test request 150.

As mentioned above, the test request 150 includes various characteristics that outline various parameters for executing the test. The characteristics include, in one implementation, request-side characteristics and server-side characteristics. The request-side characteristics relate to the requested test, a requested device, and/or a requesting party, while the server-side characteristics relate to the remote devices in the testing pool.

Regarding the request-side characteristics, in one arrangement, the request-side characteristics include an identity or identifying information regarding the requesting user, party, and/or team (herein referred to as the user); a project code; engineering hours required for the test; cost and/or budget parameters relating to the requested test or user; authorization to access specific test devices by the user, a specific test device requested by the user; timing of the test (requested start time, latest acceptable finish time, expected duration of execution, a criticality of the test (e.g., low criticality or high criticality), deadlines related to the test, whether the timing is fixed or flexible, etc.); a type of planned usage for the test device (e.g., whether the test is a smoke test, an integration test, etc.); a type of on-demand usage for the test device (e.g., CI/CD, feature testing in development, debugging, etc.); costs associated with engineering time to execute the test; and/or costs associated with delays due to unavailability of test devices. The request-side characteristics can also include preferences set by a management group of the user, for example, related to a specific budget or project.

Turning now to the server-side characteristics, in one implementation, the server-side characteristics include information regarding the remote devices in the testing pool. For example, the server-side characteristics include a number of remote devices in the testing pool; an availability and/or a suitability (e.g., a device configuration) of the remote devices to satisfy the request and operate as the test device for executing the test; whether the remote devices are online or inaccessible; a cost of use of the remote devices; a cost of a testing bench formed form a subset of the remote devices; and/or an availability of a remote devices that matches the request-side characteristics, etc.

In addition to the request-side and server-side characteristics, in one implementation, the characteristics also include costs associated with using the remote device and executing the test. These costs include, in one embodiment, resource costs and impact costs. In one implementation, the resource costs reflect direct costs associated with using the remote device such as the consumption of physical, electrical, computational, and/or communication resources. On the other hand, the impact costs, in one implementation, reflect indirect costs associated with use the remote device such as degradation of the remote device and scheduling impacts due to unavailability of the remote device during use. Each category of costs will be described in turn in further detail below.

As mentioned above, the resource costs include consumption of physical, electrical, computational, and/or communication resources of the remote device, and may also include such costs related to use of a test bench associated with the remote device. Regarding physical resources, the resource costs can include the price of the remote device and/or the test bench equipment, wear-and-tear on the remote device and/or test bench as a result of using the remote device and/or the test bench, service costs associated with the remote device and/or the test bench, cost of storage space for the remote devices and/or test bench equipment, etc.

Regarding electrical resources, the resource costs can include electricity costs that vary by location and time. As mentioned above, in some instances, the remote devices and/or test benches may be located in geographically distinct locations, for example, in different zip codes, different cities, different states, and even different countries. This may be the case when the testing equipment is owned by multi-national or global corporations that execute tests across many different regions. Oftentimes, costs of electricity vary across these locations, for example, due to varying grid structures, surcharges, taxes, tariffs, etc. Moreover, these locations can experience different seasonal pricing, demand charges, and time-of-use windows, such that a remote device hosted in one location may incur lower off-peak rates but higher daytime demand charges than a comparable device in another location. Further, in some implementations, the electricity costs include electricity and cloud service pricing further vary by day-of-week (e.g., weekday demand premiums versus weekend off-peak schedules).

In some implementations, test benches and associated hardware such as the remote devices are organized into clusters deployed in different geographic locations and arranged in various configurations, where each cluster can present distinct operating characteristics such as electrical loads, communication bandwidth costs, cloud service pricing, maintenance practices, and availability windows. The testing system 100, in one approach, treats clusters as managed groupings for allocation, comparing cluster-level costs and capacities across cities, regions, or countries and selecting a cost-effective cluster or a subset of benches within a cluster that satisfies the specified device type, timing window, and criticality while maintaining low costs. By evaluating electricity costs at the cluster level, the testing system 100 can allocate low-cost clusters while adhering to testing constraints.

Regarding computational costs, the resource costs can include device-specific electrical loads during startup and sustained operation, and metered compute usage such as CPU/GPU-hour pricing, memory usage, and storage I/O. In some implementations, these costs differ between test benches and cloud-hosted services. Moreover, in some implementations, the computational costs further include cloud service pricing that varies by provider, region, and time. Additionally, the computational costs can include time-based pricing effects for cloud services (e.g., burst pricing, promotional off-peak rates, or scheduled discounts).

Finally, regarding communication costs, the resource costs can include bandwidth charges for data transfer between geographically distinct locations of the request and the remote device, secure tunneling and encryption (e.g., VPN or TLS), quality-of-service or low-latency routing needed for real-time interactions, etc.

As mentioned above, the characteristics also impact costs, which include, in one approach, degradation of the remote device and scheduling impacts due to unavailability of the remote device. Examples of degradation include wear associated with testing, which can also increase a need for maintenance and downtime of the remote device. Scheduling impacts include opportunity costs from reserving high-demand remote devices, preempting lower-criticality sessions to satisfy urgent requests, and enforcing exclusive access windows that increase waiting time for other users.

In any case, regarding the resource costs and/or the impact costs, the testing system 100 can consider both types of costs associated with various locations, for example, the location associated with the request and one or more locations associated with the remote devices. These different locations are considered because electricity pricing, bandwidth rates, maintenance practices, and availability can vary significantly across cities, regions, and countries, and accounting for those variations enables the testing system 100 to select the remote device that achieves lower overall cost and more predictable scheduling for the specific test.

Turning now to the model(s) 160, in one approach, the testing system 100 leverages the model(s) 160 to process the test request 150, for example, to allocate a remote device to operate as the test device. The model(s) 160 may comprise various machine learning architectures, including transformer-based models (e.g., large language models (LLMs)) for processing textual data. An LLM, in one approach, is trained on datasets comprising, for example, characteristics, etc., thereby enabling the system to create and improve allocations. Of course, while LLMs are described, the model(s) 160, in further arrangements, can include deep neural networks (DNNs), recurrent neural networks (RNNs), Support Vector Machines (SVMs), clustering algorithms, Hidden Markov Models, another form of machine learning, or other suitable architectures. It should be appreciated that the separate forms of machine learning algorithms may have distinct applications, such as agent modeling, machine perception, and so on. While machine learning algorithms are described herein, it should be noted that the model(s) 160 are not limited to machine learning, and can include traditional, non-ML optimizations such as rule-based policies, linear or mixed-integer programming, or heuristic scheduling.

The model(s) 160 are, in one embodiment, stored, at least partially, in the data store 140 and may be further integrated with the optimization module 130. Additionally, the model(s) 160 can be trained on the test request 150. The model(s) 160 are, in one approach, periodically updated using new training data collected during operation and use of the testing system 100 to improve accuracy.

Moreover, it should be appreciated that machine learning algorithms are generally trained to perform a defined task. Thus, the training of the machine learning algorithm is understood to be distinct from the general use of the machine learning algorithm unless otherwise stated. That is, the testing system 100 generally trains the machine learning algorithm according to a particular training approach, which may include supervised training, self-supervised training, reinforcement learning, and so on. In contrast to training/learning of the machine learning algorithm, the testing system 100 implements the machine learning algorithm to perform inference. Thus, the general use of the machine learning algorithm is described as inference.

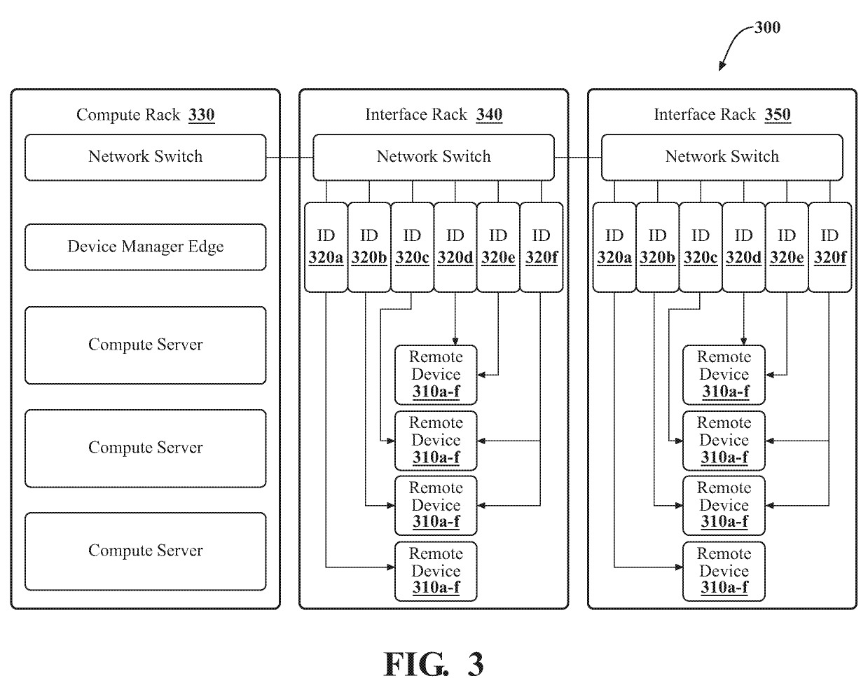

Turning now to FIG. 3, one example of a testing pool 300 is illustrated. As mentioned above, the testing pool 300, which may be implemented as a central test bench, includes remote devices 310a-f that the testing system 100 can allocate to operate as the testing device. As shown in FIG. 3, the testing pool 300 includes four remote devices 310a-f; however, it should be understood that FIG. 3 is just one schematic of the testing pool 300 and that the testing pool 300 can include another number of remote devices 310a-f and/or separate iterations of rack systems with arrangements of remote devices 310a-f. In fact, the testing pool 300 may include dozens, hundreds, or even thousands of remote devices 310a-f. In one example, the remote devices 310a-f are vehicle electronic control units (ECUs) that are provided to execute vehicle tests. Accordingly, as most vehicles contain many separate, subsystem-specific ECUs, the testing pool 300 can likewise include many of remote devices 310a-f that may be arranged together to mimic the operation of a test vehicle. It should also be noted that a portion of the remote devices 310a-f may be located remotely from a rack system.

In one embodiment, when the ECUs are installed in a vehicle, the ECUs would ordinarily be connected via a complex wiring harness. Rather than fabricating a unique harness for every configuration, in one approach, the testing system 100 includes interface devices 320a-f (IDs, which may be vehicle hardware interfaces (VHIs)) to connect the ECUs with an external network by exposing connector pins specific to that ECU as, for example, networked ports. The interface devices 320a-f, in one embodiment, each include a controller, a memory that stores configuration information (e.g., remote device identifiers and a mapping of remote device pins to bridge ports), a transceiver for network communications, and a bridge that exposes the pins for mediated access. By retrieving the stored configuration and generating a mapping of pins to ports, the interface devices 320a-f allow test services to power, control, and exchange signals with the remote devices 310a-f.

In one arrangement, multiple interface devices 320a-f can be networked and managed by an edge service/orchestrator. The edge service, in one approach, aggregates configuration information from all connected interface devices 320a-f, effectively learning what remote devices 310a-f are present and how the pins are exposed through the respective bridges. Using this aggregated information, the edge service can emulate a physical wiring harness by routing signals between remote devices 310a-f according to a harness mapping, thereby forming a virtual wire harness among multiple remote devices 310a-f and even across multiple interface devices 320a-f. This arrangement enables flexible, reusable test bench configurations, supports automated or manual testing, and allows complex multi-ECU topologies to be provisioned and reconfigured through software. While FIG. 3 shows an example of remote devices 310a-f that are ECUs provided with interface devices 320a-f, it should be understood that the remote devices 310a-f can be other devices as well, for example, other devices-under-test. For example, other remote devices 310a-f can include sensors, actuators, control or compute modules, communication gateways, or simulated/emulated units.

Moreover, as shown in FIG. 3, one example of a rack system is illustrated as it may be installed. In particular, the rack system is comprised of three primary elements, including a compute rack 330, an interface rack 340, and an interface rack 350. The compute rack 330 includes a network switch to connect with a network. The compute rack 330 further includes multiple compute servers and a device manager edge. The compute servers may execute various instances of the testing system 100 and/or different test services. Thus, the automated test programs and other software that may interact with the interfaces can be executed on the compute rack 330. The interface racks 340, 350 have similar configurations that include network switches to connect with the network and communicate with the compute rack 330. To the network switches, the interface racks 340, 350 connect multiple interface devices 320a-f to associated remote devices 310a-f. As such, the rack system provides for implementing complex virtual wire harness via edge and cloud services executing on the compute rack 330. In this way, the adaptable interface devices 320a-f improve the testing process by avoiding complexities associated with physical harnesses.

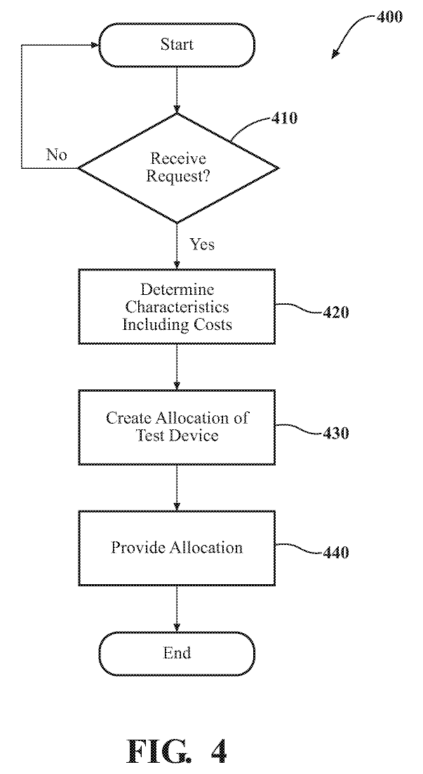

Additional aspects of the testing system 100 will be discussed in relation to FIG. 4, which illustrates a flowchart of a method 400 that is associated with allocating testing equipment. The method 400 will be discussed from the perspective of the testing system 100 of FIGS. 1 and 2. While the method 400 is discussed in connection with the testing system 100, it should be appreciated that the method 400 is not limited to being implemented within the testing system 100 but that the testing system 100 is one example of a system that may implement the method 400.

In any case, at 410, the optimization module 130 monitors for a request. The request is, in one embodiment, a request to perform a test using a remote device 310a-f from the testing pool 300. If the optimization module 130 receives a request, the optimization module 130, in one embodiment, stores the request in the data store 140. If, however, the optimization module 130 does not receive a request, the optimization module 130 continues monitoring for a request, in one embodiment.

Upon receiving the request, in one approach, the optimization module 130 determines various characteristics of the request at 420. As mentioned above, in one embodiment, these characteristics include request-side characteristics such as the identity of the requesting user, project code, criticality, requested start time and acceptable completion window, expected duration, and the type of planned or on-demand usage (e.g., smoke, integration, CI/CD, feature testing, debugging). In addition, in one implementation, the request-side characteristics include budget and cost parameters (e.g., engineering-hour costs and delay costs), authorization to access specific devices, and management preferences tied to the project. In one approach, at 420, the optimization module 130 further determines server-side characteristics, including current availability and suitability of remote devices 310a-f in the testing pool 300, device states (online/offline), compatibility with the requested configuration, and costs. Furthermore, at 420, in one implementation, the optimization module 130 further determines costs, including resource costs such as physical, electrical, computational, and communication costs across different locations, as well as impact costs from device degradation and scheduling effects.

As a result, the optimization module 130 can determine whether there exists a remote device 310a-f that is suitable to operate as the test device for executing the request, and, if so, choose the best remote device 310a-f for executing the request. As described in further detail below, in one implementation, the “best” remote device is the device that minimizes overall cost subject to the specified characteristics (e.g., timing and availability), or, for higher-criticality requests, the device that satisfies the criticality and timing constraints while keeping total costs low relative to alternative allocations.

Upon determining the characteristics, at 430, the optimization module 130, in one embodiment, creates an allocation of a remote device. More specifically, at 430, in one approach, the optimization module 130 creates an allocation by allocating one or more remote devices 310a-f to operate as a test device. In one implementation, the optimization module 130 creates the allocation based, at least in part, on the characteristics. Moreover, in one approach, creating an allocation of a remote device may involve creating an allocation of a test bench and/or a cluster. In one example, the optimization module 130 allocates a single test bench configured with one or more remote devices 310a-f that satisfy the requested device type and timing window, or it can allocate a subset of test benches within a cluster. At the cluster level, the optimization module 130 can consider cluster-specific characteristics to select the most cost-effective cluster that still meets the testing constraints. As a result, the optimization module 130 can route a test to a lower-cost cluster in another city or country, consolidate low-criticality sessions on shared benches within a cluster to reduce setup time and costs, or reserve multiple benches across a cluster when needed to minimize waiting time while keeping total cost low.

Moreover, in one embodiment, the optimization module 130 leverages one of the model(s) 160 to create the allocation. For example, the optimization module 130 can utilize a cost optimization model that considers the characteristics and costs to minimize the costs while adhering to other testing requirements. In one approach, the cost optimization model evaluates available remote devices 310a-f to minimize an objective function that accounts for some or all of the aforementioned costs.

In one example, the optimization module 130 outputs multiple optimized candidate allocations characterized by attributes such as cost, availability window, setup/reconfiguration effort, predicted waiting time, and cost. The optimization module 130 can automatically select the optimal allocation (e.g., minimizing total cost subject to timing constraints and criticality) for reservation and scheduling. In another approach, the optimization module 130 can provide the list of candidate allocations to a user for manual selection by the user. In an illustrative example, the candidate allocations for a medium-criticality request for a 4-hour session within the next 48 hours can include: (1) Allocation A: evening window today with minor setup, short waiting time, lower cost, (2) Allocation B: morning window tomorrow with no setup, longer waiting time, higher cost, and (3) Allocation C: late evening today with moderate reconfiguration, moderate waiting time, moderate cost. Using an automatic selection, the optimization module 130 would select Allocation A to abide by the cost optimization, while a user might manually select Allocation B if the user prefers to execute the test in the daytime during standard working hours.

Moreover, in one implementation, creating the allocation involves assessing costs for a group of remote devices 310a-f from the testing pool 300. For example, based on the specified criticality (e.g., low, medium, high, urgent) and the required device type (e.g., ECU model, interface configuration, bench capability), the testing system 100 identifies a group of remote devices 310a-f in the testing pool 300 that are suitable to operate as the test device for satisfying the request. The testing system 100 can then assesses costs for the remote devices 310a-f in the group, including resource costs (physical, electrical, computational, and communication) and impact costs (device degradation and scheduling effects). Using these assessed costs, the testing system 100, in one approach, allocates one or more of the remote devices 310a-f from the group to operate as the test device, selecting an allocation that minimizes overall cost while satisfying timing, availability, and criticality constraints.

In any case, based on the optimized outcome, in one approach, the optimization module 130 provides the allocation at 440. More specifically, in one approach, the optimization module 130 provides the allocation to reserve the remote device 310a-f and schedule a test session for the user. For example, the optimization module 130 automatically reserves the selected remote device 310a-f and/or automatically schedules a test session within the acceptable timing window for executing the request. To do so, in one approach, the optimization module 130 updates calendar entries or queue positions to reflect the reservation. The optimization module 130 can also issue notifications or credentials required to initiate the session. In another example, the optimization module 130 outputs information to the user about the reserved remote device 310a-f and/or the test session, for example, when the test session should be reserved, when the request should be executed, etc. The information can also include an identifier for the remote device 310a-f, configuration of the test, start time, expected duration, etc.

In one implementation, providing the allocation includes modifying access to the remote device 310a-f itself. For example, the optimization module 130 can provide the allocation by allowing the requesting user to access the remote device 310a-f as the test device to execute the request, while blocking other users from accessing the remote device 310a-f for the duration of the test. As a result, the optimization module 130 enforces exclusive access to the remote device 310a-f during the session and releases the remote device 310a-f upon completion of the request or a timeout.

As mentioned above, in one approach, the optimization module 130 considers a criticality of the request in the optimization and dynamically allocates the remote device 310a-f according to the specified criticality. For example, for high-criticality or urgent requests, the optimization module 130 prioritizes queue placement, preempts lower-criticality requests, and selects devices with the shortest setup time to minimize waiting times. For medium-criticality requests, the optimization module 130 can prioritize near-term availability while balancing utilization and cost. For low-criticality requests, the optimization module 130 can favor off-peak windows, cost-efficient devices, and consolidated scheduling.

The criticality can be expressed in several forms, either provided for in the request or determined by the optimization module 130. Examples of measures of criticality include a binary non-urgent versus urgent flag; a multi-level classification (e.g., low, medium, high, emergency, etc.); or a numerical scale (e.g., 1–10 where 10 represents the most critical). In one implementation, when a numeric scale is used, the optimization module 130 can escalate scheduling urgency as the score increases or as deadlines approach. In another example, the optimization module 130 can derive the criticality from deadlines (e.g., hard deadline within 24 hours versus flexible completion within a week), program phase (e.g., validation versus exploratory testing), or business impact (e.g., safety-related vs. routine testing).

Moreover, for low-criticality requests, the optimization module 130, in one implementation, allocates a suitable remote device 310a-f from the testing pool 300 to operate as the test device. In some instances, the remote device 310a-f is suitable for executing the test but may not meet all of the preferences of the user specified in the request. For example, the optimization module 130 may allocate an earlier-generation ECU that is functionally compatible but lacks optional performance requested by the user, schedule the session in an off-peak overnight window rather than the preferred daytime slot, or allocate a shared test bench configuration instead of a dedicated single-device configuration. In another example, the optimization module 130 may route the test to a geographically distant edge service with available capacity, resulting in a slightly higher network latency that remains within acceptable limits. The optimization module 130 can also consolidate multiple low-criticality requests on the same test bench to reduce setup time. In any case, the optimization module 130 seeks to minimize waiting time and overall cost while reserving optimal devices and timing windows for high-criticality requests.

The arrangements disclosed herein provide the benefit of dynamically allocating testing equipment with a focus on minimizing costs across different locations, accounting for variations in electricity pricing, bandwidth rates, cloud service charges, maintenance practices, and availability in distinct cities, regions, and countries. By evaluating these location-specific factors, the arrangements described here anticipate demand and select remote devices and time windows that reduce overall spend while meeting project timing and criticality constraints, thereby shortening waiting times and avoiding high-cost periods. This approach enables proactive provisioning and reservation aligned with budget preferences, yielding minimized costs for use of geographically distributed testing equipment.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/ units or less, within 14 degrees/percent/ units or less, within 13 degrees/percent/ units or less, within 12 degrees/percent/ units or less, within 11 degrees/percent/ units or less, within 10 degrees/percent/ units or less, within 9 degrees/percent/ units or less, within 8 degrees/percent/ units or less, within 7 degrees/percent/ units or less, within 6 degrees/percent/ units or less, within 5 degrees/percent/ units or less, within 4 degrees/percent/ units or less, within 3 degrees/percent/ units or less, within 2 degrees/percent/ units or less, or within 1 degree/percent/ unit or less. In some examples, “substantially” can include being within normal manufacturing tolerances.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A testing system, comprising:
a processor; and
a memory communicably coupled to the processor and storing:
an allocation module including instructions that, when executed by the processor, cause the processor to:
receive a request to perform a test involving at least one test device;
determine characteristics associated with the request including costs;
create, using a cost optimization model based, at least in part, on the characteristics, an allocation of a remote device from a testing pool to operate as the at least one test device for executing the test; and
provide the allocation to reserve the remote device and schedule a test session.

2. The testing system of claim 1, wherein the instructions to determine the costs include instructions to identify one or more of resource costs and impact costs associated with use of the remote device, wherein the resource costs include consumption of physical, electrical, computational, or communication resources of the remote device, and wherein the impact costs include degradation of the remote device and scheduling impacts due to unavailability of the remote device.

3. The testing system of claim 2, wherein the resource costs include an electricity cost associated with using the remote device and communication bandwidths associated with geographically distinct locations of the remote device and the request.

4. The testing system of claim 1, wherein the instructions to determine the characteristics include instructions to determine a criticality of the request and a type of device to satisfy the request, and wherein the instructions to create the allocation include instructions to:
identify, based on the criticality and the type of device, a group of remote devices in the testing pool that satisfy the request;
assess the costs for remote devices in the group; and
allocate, based on the costs, one or more of the remote devices from the group to operate as the at least one test device.

5. The testing system of claim 1, wherein the instructions to determine the characteristics include instructions to determine a criticality of the request, and wherein the instructions to provide the allocation include instructions to dynamically allocate the remote device to operate as the at least one test device according to the criticality.

6. The testing system of claim 1, wherein the instructions to determine the characteristics include instructions to determine a type of test device to satisfy the request for the at least one test device, a criticality, a time frame for executing the test, and an availability of a device matching device to function as the remote device from the testing pool, and
wherein the instructions to create the allocation include instructions to use a machine learning model that performs a cost optimization based on the characteristics and the costs.

7. The testing system of claim 1, wherein the instructions to provide the allocation include instructions to access the at least one test device for executing the test and block other users from accessing the at least one test device for a duration of the test.

8. A non-transitory computer-readable medium including instructions that, when executed by a processor, cause the processor to:
receive a request to perform a test involving at least one test device;
determine characteristics associated with the request including costs;
create, using a cost optimization model based, at least in part, on the characteristics, an allocation of a remote device from a testing pool to operate as the at least one test device for executing the test; and
provide the allocation to reserve the remote device and schedule a test session.

9. The non-transitory computer-readable medium of claim 8, wherein the instructions to determine the costs include instructions to identify one or more of resource costs and impact costs associated with use of the remote device, wherein the resource costs include consumption of physical, electrical, computational, or communication resources of the remote device, and wherein the impact costs include degradation of the remote device and scheduling impacts due to unavailability of the remote device.

10. The non-transitory computer-readable medium of claim 9, wherein the resource costs include an electricity cost associated with using the remote device and communication bandwidths associated with geographically distinct locations of the remote device and the request.

11. The non-transitory computer-readable medium of claim 8, wherein the instructions to determine the characteristics include instructions to determine a criticality of the request and a type of device to satisfy the request, and wherein the instructions to create the allocation include instructions to:
identify, based on the criticality and the type of device, a group of remote devices in the testing pool that satisfy the request;
assess the costs for remote devices in the group; and
allocate, based on the costs, one or more of the remote devices from the group to operate as the at least one test device.

12. The non-transitory computer-readable medium of claim 8, wherein the instructions to determine the characteristics include instructions to determine a criticality of the request, and wherein the instructions to provide the allocation include instructions to dynamically allocate the remote device to operate as the at least one test device according to the criticality.

13. The non-transitory computer-readable medium of claim 8, wherein the instructions to determine the characteristics include instructions to determine a type of test device to satisfy the request for the at least one test device, a criticality, a time frame for executing the test, and an availability of a device matching device to function as the remote device from the testing pool, and
wherein the instructions to create the allocation include instructions to use a machine learning model that performs a cost optimization based on the characteristics and the costs.

14. A method, comprising:
receiving a request to perform a test involving at least one test device;
determining characteristics associated with the request including costs;
creating, using a cost optimization model based, at least in part, on the characteristics, an allocation of a remote device from a testing pool to operate as the at least one test device for executing the test; and
providing the allocation to reserve the remote device and schedule a test session.

15. The method of claim 14, wherein determining the costs includes identifying one or more of resource costs and impact costs associated with use of the remote device, wherein the resource costs include consumption of physical, electrical, computational, or communication resources of the remote device, and wherein the impact costs include degradation of the remote device and scheduling impacts due to unavailability of the remote device.

16. The method of claim 15, wherein the resource costs include an electricity cost associated with using the remote device and communication bandwidths associated with geographically distinct locations of the remote device and the request.

17. The method of claim 14, wherein determining the characteristics includes determining a criticality of the request and a type of device to satisfy the request, and wherein creating the allocation includes:
identifying, based on the criticality and the type of device, a group of remote devices in the testing pool that satisfy the request;
assessing the costs for remote devices in the group; and
allocating, based on the costs, one or more of the remote devices from the group to operate as the at least one test device.

18. The method of claim 14, wherein determining the characteristics includes determining a criticality of the request, and wherein providing the allocation includes dynamically allocating the remote device to operate as the at least one test device according to the criticality.

19. The method of claim 14, wherein determining the characteristics includes determining a type of test device to satisfy the request for the at least one test device, a criticality, a time frame for executing the test, and an availability of a device matching device to function as the remote device from the testing pool, and
wherein creating the allocation includes using a machine learning model that performs a cost optimization based on the characteristics and the costs.

20. The method of claim 14, wherein providing the allocation includes accessing the at least one test device for executing the test and blocking other users from accessing the at least one test device for a duration of the test.
